(19) United States
(12) Patent Application Publication
(10) Pub. No.: US 2020/0052327 A1
(43) Pub. Date: Feb. 13, 2020

(54) COMPOSITE SOLID ELECTROLYTE AND ALL-SOLID-STATE BATTERY

(71) Applicant: TOYOTA JIDOSHA KABUSHIKI KAISHA, Toyota-shi (JP)

(72) Inventor: Naoki OSADA, Sunto-gun (JP)

(73) Assignee: TOYOTA JIDOSHA KABUSHIKI KAISHA, Toyota-shi (JP)

(21) Appl. No.: 16/533,124

(22) Filed: Aug. 6, 2019

(30) Foreign Application Priority Data
Aug. 9, 2018 (JP) 2018-150803

(51) Int. Cl. H01M 10/0562; H01M 10/0585; H01M 10/0525

(52) U.S. Cl. CPC H01M 10/0562; H01M 10/0585; H01M 2300/0091; H01M 2300/0068; H01M 10/0525

(57) ABSTRACT

A composite solid electrolyte configured to strike a balance between ion conductivity and peel strength when it is formed into a layer by pressure forming, and an all-solid-state battery comprising the composite solid electrolyte. The all-solid-state battery comprises a composite solid electrolyte containing first sulfide-based solid electrolyte particles and second sulfide-based solid electrolyte particles having a smaller Young's modulus than the first sulfide-based solid electrolyte particles; wherein an average particle diameter of the first sulfide-based solid electrolyte particles is smaller than the second sulfide-based solid electrolyte particles.

### TECHNICAL FIELD

The disclosure relates to a composite solid electrolyte and an all-solid-state battery.

### BACKGROUND

In recent years, with the rapid spread of IT and communication devices such as personal computers, camcorders and cellular phones, great importance has been attached to the development of batteries that can be used as the power source of such devices. In the automobile industry, etc., high-power and high-capacity batteries for electric vehicles and hybrid vehicles are under development.

Of all-solid-state batteries, an all-solid-state lithium ion battery has attracted attention, due to its high energy density resulting from the use of a battery reaction accompanied by lithium ion transfer, and due to the use of a solid electrolyte as the electrolyte present between the cathode and the anode, in place of a liquid electrolyte containing an organic solvent.

For the purpose of eliminating variation in surface pressure applied to an electrode layer or a solid electrolyte layer, Patent Literature 1 discloses an all-solid-state battery in which the Young's modulus of a sulfide-based solid electrolyte contained in the outer peripheral region of at least one of a cathode layer, an anode layer and a solid electrolyte layer, is smaller than the Young's modulus of a sulfide-based solid electrolyte contained in an inside region located inside the outer periphery region.

For the purpose of suppressing peeling off between an electrode and a solid oxide electrolyte and suppressing cracking of the solid oxide electrolyte, Patent Literature 2 discloses a solid oxide fuel cell containing, as a solid oxide electrolyte, an electrolyte material made of a solid oxide (e.g., zirconia) and a low Young's modulus material having insulating properties and a lower Young's modulus than the electrolyte material (e.g., silica).

Patent Literature 1: Japanese Patent Application Laid-Open (JP-A) No. 2011-154902

Patent Literature 2: JP-A No. 2010-123416

A conventional solid electrolyte has a problem in that it cannot strike a sufficient balance between ion conductivity and peel strength when it is formed into a layer (e.g., a solid electrolyte layer) by pressure forming.

### SUMMARY

In light of the above circumstance, an object of the disclosed embodiments is to provide a composite solid electrolyte configured to strike a balance between ion conductivity and peel strength when it is formed into a layer by pressure forming. Another object of the disclosed embodiments is to provide an all-solid-state battery comprising the composite solid electrolyte.

In a first embodiment, there is provided an all-solid-state battery comprising a cathode comprising a cathode layer, an anode comprising an anode layer, and a solid electrolyte layer disposed between the cathode layer and the anode layer,

wherein the all-solid-state battery comprises a composite solid electrolyte containing first sulfide-based solid electrolyte particles and second sulfide-based solid electrolyte particles having a smaller Young's modulus than the first sulfide-based solid electrolyte particles;

wherein an average particle diameter of the first sulfide-based solid electrolyte particles is smaller than the second sulfide-based solid electrolyte particles; and

wherein the composite solid electrolyte is contained in at least one layer selected from the group consisting of the cathode layer, the anode layer and the solid electrolyte layer.

The first sulfide-based solid electrolyte particles contained in the composite solid electrolyte may account for 0.5 mass % to 15 mass % of the total mass of the composite solid electrolyte.

The first sulfide-based solid electrolyte particles contained in the composite solid electrolyte may account for 1 mass % to 5 mass % of the total mass of the composite solid electrolyte.

A Young's modulus of the first sulfide-based solid electrolyte particles maybe from 30 GPa to 150 GPa, and the Young's modulus of the second sulfide-based solid electrolyte particles may be from 15 GPa to 25 GPa.

A length of a long axis of the first sulfide-based solid electrolyte particles may be from 0.3 μm to 1 μm, and a length of a long axis of the second sulfide-based solid electrolyte particles may be from 2 μm to 3 μm.

An aspect ratio of the first sulfide-based solid electrolyte particles may be from 1.5 to 5.0, and an aspect ratio of the second sulfide-based solid electrolyte particles may be from 1.0 to 1.2.

The first sulfide-based solid electrolyte particles may be disposed in an outer peripheral region of the second sulfide-based solid electrolyte particles.

In another embodiment, there is provided a composite solid electrolyte for all-solid-state batteries each comprising a cathode comprising a cathode layer, an anode comprising an anode layer, and a solid electrolyte layer disposed between the cathode layer and the anode layer,

wherein the composite solid electrolyte comprises first sulfide-based solid electrolyte particles and second sulfide-based solid electrolyte particles having a smaller Young's modulus than the first sulfide-based solid electrolyte particles, and

wherein an average particle diameter of the first sulfide-based solid electrolyte particles is smaller than the second sulfide-based solid electrolyte particles.

According to the disclosed embodiments, a composite solid electrolyte configured to strike a balance between ion conductivity and peel strength when it is formed into a layer by pressure forming, and an all-solid-state battery comprising the composite solid electrolyte, can be provided.

### BRIEF DESCRIPTION OF THE DRAWINGS

In the accompanying drawings,

FIG. 1 is a schematic view of an example of the composite solid electrolyte before pressure forming;

FIG. 2 is a schematic view of an example of the composite solid electrolyte after pressure forming;

FIG. 3 is a schematic sectional view of an example of the all-solid-state battery of the disclosed embodiments; and

FIG. 4 is a graph showing a relation between the content rate of the first sulfide-based solid electrolyte particles in the composite solid electrolyte, the Li ion conductivity of the solid electrolyte layer, and the peel strength of the solid electrolyte layer.

### DETAILED DESCRIPTION

The all-solid-state battery of the disclosed embodiments is an all-solid-state battery comprising a cathode comprising a cathode layer, an anode comprising an anode layer, and a solid electrolyte layer disposed between the cathode layer and the anode layer,

wherein the all-solid-state battery comprises a composite solid electrolyte containing first sulfide-based solid electrolyte particles and second sulfide-based solid electrolyte particles having a smaller Young's modulus than the first sulfide-based solid electrolyte particles;

wherein an average particle diameter of the first sulfide-based solid electrolyte particles is smaller than the second sulfide-based solid electrolyte particles; and

wherein the composite solid electrolyte is contained in at least one layer selected from the group consisting of the cathode layer, the anode layer and the solid electrolyte layer.

An all-solid-state battery is formed of aggregated particles. Since the all-solid-state battery is an aggregate of particles, it is generally low in electrode stiffness and high in fragility.

Accordingly, formation of the all-solid-state battery by applying very high pressure, or increasing the strength of an electrode layer or solid electrolyte layer by adding a shape retaining agent (e.g., a polymer) thereto, is carried out.

Meanwhile, these methods become a cause of a decrease in the productivity of the all-solid-state battery or a decrease in the performance of the all-solid-state battery.

As a result of research, it was found that by use of the composite solid electrolyte obtained by mixing two kinds of sulfide-based solid electrolyte particles different in hardness, size and (as needed) form as a material for a layer such as a solid electrolyte layer, adhesion between the solid electrolyte particles in the layer can be increased, and the layer can strike a balance between ion conductivity and peel strength.

The reason is presumed as follows: since sulfide-based solid electrolyte particles that are relatively small and hard are mixed with sulfide-based solid electrolyte particles that are relatively large and soft, when a layer is formed by pressure forming, a so-called anchor effect (in which the soft sulfide-based solid electrolyte particles are deformed by pressure forming and an interface is formed between the particles, while the hard sulfide-based solid electrolyte particles are caught on the soft sulfide-based solid electrolyte particles) is exerted, thereby increasing the hardness of the layer. In addition, since the composite solid electrolyte of the disclosed embodiments is composed of an ion conductor only, it is not needed to incorporate an ion conduction-disturbing material in the layer, and the layer can obtain desired ion conductivity.

### [Composite Solid Electrolyte]

The composite solid electrolyte of the disclosed embodiments is a composite solid electrolyte for all-solid-state batteries each comprising a cathode comprising a cathode layer, an anode comprising an anode layer, and a solid electrolyte layer disposed between the cathode layer and the anode layer,

wherein the composite solid electrolyte comprises first sulfide-based solid electrolyte particles and second sulfide-based solid electrolyte particles having a smaller Young's modulus than the first sulfide-based solid electrolyte particles, and

wherein an average particle diameter of the first sulfide-based solid electrolyte particles is smaller than the second sulfide-based solid electrolyte particles.

The composite solid electrolyte contains the first sulfide-based solid electrolyte particles and the second sulfide-based solid electrolyte particles having a smaller Young's modulus than the first sulfide-based solid electrolyte particles. From the viewpoint of increasing ion conductivity, the composite solid electrolyte maybe composed of the first sulfide-based solid electrolyte particles and the second sulfide-based solid electrolyte particles.

The Young's modulus is an index of particle hardness. As the Young's modulus increases, the particles gets harder and less fragile.

Accordingly, the first sulfide-based solid electrolyte particles are particles harder than the second sulfide-based solid electrolyte particles.

Accordingly, the composite solid electrolyte of the disclosed embodiments is characterized in that the relatively small and hard particles are disposed around the relatively large and soft particles.

For the Young's modulus of the first sulfide-based solid electrolyte particles, the lower limit may be more than 25 GPa, may be 30 GPa or more, or may be 80 GPa or more. On the other hand, the upper limit may be 300 GPa or less, or it may be 150 GPa or less.

For the Young's modulus of the second sulfide-based solid electrolyte particles, the lower limit may be 15 GPa or more. On the other hand, the upper limit may be 25 GPa or less.

The Young's moduli can be measured by a nanoindenter or a scanning probe microscope (SPM), for example.

The average particle diameter of the first sulfide-based solid electrolyte particles is smaller than the second sulfide-based solid electrolyte particles.

In the disclosed embodiments, unless otherwise noted, the average particle diameter of particles is a volume-based median diameter (D50) measured by laser diffraction/scattering particle size distribution measurement. Also in the disclosed embodiments, the median diameter (D50) of particles is a diameter at which, when the particle diameters of particles are arranged in ascending order, the accumulated volume of the particles is half (50%) the total volume of the particles (volume average diameter).

For the average particle diameter of the first sulfide-based solid electrolyte particles, the lower limit maybe 0.1 μm or more, or it may be 0.5 μm or more. On the other hand, the upper limit may be less than 2 μm, may be 1 μm or less, or may be 0.9 μm or less.

For the average particle diameter of the second sulfide-based solid electrolyte particles, the lower limit may be 2 μm or more. On the other hand, the upper limit may be 5 μm or less, or it may be 3 μm or less.

The aspect ratio of the first sulfide-based solid electrolyte particles may be larger than the second sulfide-based solid electrolyte particles.

The aspect ratio is a ratio of the long axis length of particles to the short axis length thereof. It is an index indicating the following: as the aspect ratio gets closer to 1, the particle form gets closer to a spherical form, and as the aspect ratio increases larger than 1, the particle form gets closer to an acicular form.

Accordingly, the form of the first sulfide-based solid electrolyte particles may be a more acicular form than the second sulfide-based solid electrolyte particles.

For the aspect ratio of the first sulfide-based solid electrolyte particles, the lower limit may be more than 1.2, may be 1.5 or more, or may be 2 or more. On the other hand, the upper limit may be 5.0 or less, or it may be 4 or less.

For the aspect ratio of the second sulfide-based solid electrolyte particles, the lower limit may be 1.0 or more. On the other hand, the upper limit may be 1.2 or less. The form of the second sulfide-based solid electrolyte particles maybe a spherical form. Accordingly, the aspect ratio of the second sulfide-based solid electrolyte particles may be 1.0.

For example, the aspect ratio of the particles can be calculated as follows. The longest line segment of the principal surface of the particles is determined as the long axis; of line segments perpendicular to the long axis, the longest one is determined as the short axis; the long axis length and the short axis length are calculated by use of a transmission electron microscope (hereinafter referred to as TEM), a scanning electron microscope (hereinafter referred to as SEM) or the like; and the value of the long axis length with respect to the short axis length is calculated as the aspect ratio.

For the long axis length of the first sulfide-based solid electrolyte particles, the lower limit may be 0.3 μm or more. On the other hand, the upper limit may be less than 2.0 μm, or it may be 1.0 μm or less.

For the long axis length of the second sulfide-based solid electrolyte particles, the lower limit may be 2.0 μm or more. On the other hand, the upper limit may be 5.0 μm or less, or it may be 3.0 μm or less.

The long axis length of the particles can be measured by use of a transmission electron microscope (TEM), a scanning electron microscope (SEM) or the like.

More specifically, the long axis length may be calculated as follows: for a particle shown on a TEM or SEM image taken at an appropriate magnification (for example, at a magnification of from 50000× to 1000000×), the long axis length may be calculated. Also, this long axis length calculation by TEM or SEM observation may carried out on some particles of the same type, and the average of the long axis lengths of the particles may be calculated as the long axis length of the particles.

For the content rate of the first sulfide-based solid electrolyte particles in the composite solid electrolyte, the lower limit may be 0.5 mass % or more of the total mass of the composite solid electrolyte, or it may be 1 mass % or more. On the other hand, the upper limit may be 20 mass % or less of the total mass of the composite solid electrolyte, may be 15 mass % or less, may be 10 mass % or less, or may be 5 mass % or less.

For the content rate of the second sulfide-based solid electrolyte particles in the composite solid electrolyte, the lower limit may be 80 mass % or more of the total mass of the composite solid electrolyte, may be 85 mass % or more, may be 90 mass % or more, or may be 95 mass % or more. On the other hand, the upper limit may be 99.5 mass % or less of the total mass of the composite solid electrolyte, or it may be 99 mass % or less.

As the sulfide-based solid electrolyte that is usable as the composite solid electrolyte, examples include, but are not limited to, Li₂S—P₂S₅, Li₂S—SiS₂, LiX—Li₂S—SiS₂, LiX—Li₂S—P₂S₅, LiX—Li₂O—Li₂S—P₂S₅, LiX—Li₂S—P₂O₅, LiX—Li₃PO₄—P₂S₅ and Li₃PS₄. The “Li₂S—P₂S₅” means a material composed of a raw material composition containing Li₂S and P₂S₅, and the same applies to other solid electrolytes. Also, “X” in the “LiX” means at least one halogen element selected from the group consisting of F, Cl, Br and I.

The sulfide-based solid electrolyte used as the material for the first sulfide-based solid electrolyte particles may be Li₆PS₅Cl, Li₃PS₄, Li₁₀GeP₂S₁₂ or Li₄P₂S₆, for example.

The sulfide-based solid electrolyte used as the material for the second sulfide-based solid electrolyte particles may be LiI—LiBr—Li₃PS₄, LiI—Li₃PS₄, LiBr—Li₃PS₄, LiI—Li₇PS₁₁ or LiBr—Li₇P₃S₁₁, for example.

The sulfide-based solid electrolytes may be a glass, a crystal material or a glass ceramic. The glass can be obtained by amorphizing a raw material composition (such as a mixture of Li₂S and P₂S₅). The raw material composition can be amorphized by mechanical milling, for example. The mechanical milling may be dry mechanical milling or wet mechanical milling. The mechanical milling may be the latter because attachment of the raw material composition to the inner surface of a container, etc., can be prevented. The glass ceramic can be obtained by heating a glass. The crystal material can be obtained by developing a solid state reaction of the raw material composition, for example.

In the all-solid-state battery of the disclosed embodiments, the composite solid electrolyte may be contained in at least one layer selected from the group consisting of the cathode layer, the anode layer and the solid electrolyte layer. The composite solid electrolyte may be contained in the solid electrolyte layer, from the viewpoint of striking a better balance between ion conductivity and peel strength when the composite solid electrolyte is formed into a layer by pressure forming.

In the disclosed embodiments, the composite solid electrolyte contained in at least one layer selected from the group consisting of the cathode layer, the anode layer and the solid electrolyte layer, means the composite solid electrolyte formed into the layer by pressure forming. Accordingly, the composite solid electrolyte of the disclosed embodiments may be the composite solid electrolyte subjected to pressure forming.

Also, the composite solid electrolyte of the disclosed embodiments is a composite solid electrolyte for all-solid-state batteries.

For the all-solid-state battery of the disclosed embodiments, the first sulfide-based solid electrolyte particles in the composite solid electrolyte may be disposed in the outer peripheral region of the second sulfide-based solid electrolyte particles.

In the disclosed embodiments, the outer peripheral region is a region formed by a gap between the second sulfide-based solid electrolyte particles.

In the disclosed embodiments, as the state where the first sulfide-based solid electrolyte particles are disposed in the outer peripheral region of the second sulfide-based solid electrolyte particles, examples include, but are not limited to, a state where the first sulfide-based solid electrolyte particles are present in the region formed by the gap between the second sulfide-based solid electrolyte particles.

Also in the disclosed embodiments, the state where the first sulfide-based solid electrolyte particles are disposed in the outer peripheral region of the second sulfide-based solid electrolyte particles encompasses a state where at least part of the first sulfide-based solid electrolyte particles are embedded in at least part of the surface of the second sulfide-based solid electrolyte particles by the pressure-forming of the composite solid electrolyte and the first sulfide-based solid electrolyte particles are caught on the second sulfide-based solid electrolyte particles.

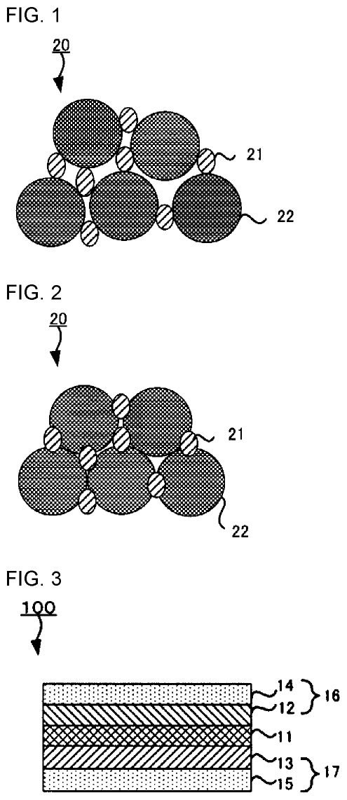

FIG. 1 is a schematic view of an example of the composite solid electrolyte before pressure forming.

As shown in FIG. 1, a composite solid electrolyte 20 contains first sulfide-based solid electrolyte particles 21 and second sulfide-based solid electrolyte particles 22. The first sulfide-based solid electrolyte particles 21 are disposed in the outer peripheral region of the second sulfide-based solid electrolyte particles 22 (i.e., in the gap between the particles 22), and the first sulfide-based solid electrolyte particles 21 are in contact with the second sulfide-based solid electrolyte particles 22.

FIG. 2 is a schematic view of an example of the composite solid electrolyte after pressure forming.

As shown in FIG. 2, for the composite solid electrolyte 20, the interface between the second sulfide-based solid electrolyte particles 22 is put in a better state by the pressure forming. Also, at least part of the first sulfide-based solid electrolyte particles 21 are embedded in at least part of the surface of the second sulfide-based solid electrolyte particles 22. Accordingly, it is presumed that the anchor effect is exerted; adhesion between the particles is increased; and when the composite solid electrolyte 20 is formed into a layer (e.g., the solid electrolyte layer), the strength of the layer is increased.

FIG. 3 is a schematic sectional view of an example of the all-solid-state battery of the disclosed embodiments.

As shown in FIG. 3, an all-solid-state battery 100 comprises a cathode 16 comprising a cathode layer 12 and a cathode current collector 14, an anode 17 comprising an anode layer 13 and an anode current collector 15, and a solid electrolyte layer 11 disposed between the cathode 16 and the anode 17.

### [Cathode]

The cathode comprises at least the cathode layer and the cathode current collector.

The cathode layer contains a cathode active material. As optional components, the cathode layer may contain the composite solid electrolyte of the disclosed embodiments, a solid electrolyte other than the composite solid electrolyte of the disclosed embodiments, an electroconductive material and a binder.

The type of the cathode active material is not particularly limited. As the cathode active material, examples include, but are not limited to, LiCoO₂, LiNiₓCo₁₋ₓO₂ (0<x<1), LiNi_{1/3}Co_{1/3}Mn_{1/3}O₂, LiMnO₂, different element-substituted Li—Mn spinels (such as LiMn_{1.5}Ni_{0.5}O₄, LiMn_{1.5}Al_{0.5}O₄, LiMn_{1.5}Mg_{0.5}O₄, LiMn_{1.5}Co_{0.5}O₄, LiMn_{1.5}Fe_{0.5}O₄ and LiMn_{1.5}Zn_{0.5}O₄), lithium titanates (such as Li₄Ti₅O₁₂), lithium metal phosphates (such as LiFePO₄, LiMnPO₄, LiCoPO₄ and LiNiPO₄) transition metal oxides (such as V₂O₅ and MoO₃), TiS₂, LiCoN, Si, SiO₂, Li₂SiO₃, Li₄SiO₄, and lithium storage intermetallic compounds (such as Mg₂Sn, Mg₂Ge, Mg₂Sb and Cu₃Sb).

The form of the cathode active material is not particularly limited. It may be a particulate form.

A coating layer containing a Li ion conducting oxide may be formed on the surface of the cathode active material. This is because a reaction between the cathode active material and the solid electrolyte can be suppressed.

As the Li ion conducting oxide, examples include, but are not limited to, LiNbO₃, Li₄Ti₅O₁₂ and Li₃PO₄. For the thickness of the coating layer, the lower limit may be 0.1 nm or more, or it may be 1 nm or more, for example. On the other hand, the upper limit may be 100 nm or less, or it may be 20 nm or less, for example. The coverage of the coating layer on the cathode active material surface may be 70% or more, or it may be 90% or more, for example.

As the solid electrolyte, examples include, but are not limited to, an oxide-based solid electrolyte and a sulfide-based solid electrolyte.

The sulfide-based solid electrolyte will not be described here, since it is the same as the sulfide-based solid electrolyte that is usable in the above-described composite solid electrolyte.

As the oxide-based solid electrolyte, examples include, but are not limited to, Li_{6.25}La₃Zr₂Al_{0.25}O₁₂, Li₃PO₄, and Li₃₊ₓPO₄₋ₓNₓ (LiPON).

The form of the solid electrolyte may be a particulate form. When the solid electrolyte is in a particulate form, for the average particle diameter (D50) of the particles, the lower limit may be 0.01 μm or more, for example. On the other hand, the upper limit may be 10 μm or less, or it may be 5 μm or less, for example.

As the solid electrolyte, one or more kinds of solid electrolytes may be used.

The content of the composite solid electrolyte of the disclosed embodiments in the cathode layer and that of the solid electrolyte other than the composite solid electrolyte in the cathode layer, are not particularly limited.

As the electroconductive material, examples include, but are not limited to, a carbonaceous material and a metal material. As the carbonaceous material, examples include, but are not limited to, carbon blacks such as acetylene black (AB) and Ketjen Black (KB), and fibrous carbonaceous materials such as vapor-grown carbon fiber (VGCF), carbon nanotube (CNT) and carbon nanofiber (CNF).

The content of the electroconductive material in the cathode layer is not particularly limited.

As the binder, examples include, but are not limited to, acrylonitrile-butadiene rubber (ABR), butadiene rubber (BR), polyvinylidene fluoride (PVdF) and styrene-butadiene rubber (SBR). The content of the binder in the cathode layer is not particularly limited.

The thickness of the cathode layer is not particularly limited.

The method for forming the cathode layer is not particularly limited. As the method, examples include, but are not limited to, pressure-forming a powdered cathode mix that contains the cathode active material and, as needed, other components.

### [Cathode Current Collector]

As the cathode current collector, a conventionally-known metal that is usable as a current collector in all-solid-state batteries, can be used. As the metal, examples include, but are not limited to, a metal material containing one or more elements selected from the group consisting of Cu, Ni, Al, V, Au, Pt, Mg, Fe, Ti, Co, Cr, Zn, Ge and In.

The form of the cathode current collector is not particularly limited. As the form, examples include, but are not limited to, various kinds of forms such as a foil form and a mesh form.

The form of the whole cathode is not particularly limited. It may be a sheet form. In this case, the thickness of the whole cathode is not particularly limited. It can be determined depending on desired performance.

### [Solid Electrolyte Layer]

The solid electrolyte layer contains at least one of the composite solid electrolyte of the disclosed embodiments and a solid electrolyte other than the composite solid electrolyte of the disclosed embodiments. The solid electrolyte layer may contain the composite solid electrolyte of the disclosed embodiments.

The content rate of the composite solid electrolyte of the disclosed embodiments in the solid electrolyte layer, is not particularly limited. For example, it may be 50 mass % or more, may be in a range of from 60 mass % to 100 mass %, may be in a range of from 70 mass % to 100 mass %, or may be 100 mass %.

The solid electrolyte contained in the solid electrolyte layer, that is, the solid electrolyte other than the composite solid electrolyte of the disclosed embodiments, will not be described here since it is the same as the solid electrolyte that can be contained in the above-described cathode. The material used for the solid electrolyte may be the same as or different from the material used for the composite solid electrolyte.

The content rate of the solid electrolyte in the solid electrolyte layer is not particularly limited. For example, it may be 50 mass % or more, may be in a range of from 60 mass % to 100 mass %, may be in a range of from 70 mass % to 100 mass %, or may be 100 mass %.

From the viewpoint of exerting plasticity, etc., a binder for binding the solid electrolyte particles can be incorporated in the solid electrolyte layer. As the binder, examples include, but are not limited to, a binder that can be incorporated in the above-described cathode.

The content rate of the binder in the solid electrolyte layer may be 5 mass % or less.

The form of the solid electrolyte layer is not particularly limited. It may be a sheet form.

The thickness of the solid electrolyte layer is not particularly limited. It is generally 0.1 μm or more and 1 mm or less.

As the method for forming the solid electrolyte layer, examples include, but are not limited to, pressure-forming a powdered composite solid electrolyte material that contains the composite solid electrolyte of the disclosed embodiments and, as needed, other components. In the case of pressure-forming the powdered composite solid electrolyte material, generally, a press pressure of 1 MPa or more and 600 MPa or less is applied.

In the disclosed embodiments, by the pressure forming, the anchor effect is exerted between the first and second sulfide-based solid electrolyte particles in the composite solid electrolyte, and the peel strength of the solid electrolyte layer can be increased.

The pressure applying method is not particularly limited. As the method, examples include, but are not limited to, applying pressure by use of a plate press machine, a roll press machine, etc.

For the lithium ion conductivity of the solid electrolyte layer, the lower limit may be 0.5 mS/cm or more, or it may be 0.8 mS/cm or more. On the other hand, the upper limit is not particularly limited and may be as large as possible. The upper limit may be less than 1.5 mS/cm, or it may be 1.4 mS/cm or less.

For the peel strength of the solid electrolyte layer, the lower limit may be more than 0.2 kN/m, or it may be 0.3 kN/m or more. On the other hand, the upper limit is not particularly limited and may be as large as possible. The upper limit may be 0.7 kN/m or less.

### [Anode]

The anode comprises an anode layer and an anode current collector.

The anode layer contains an anode active material. As optional components, the anode layer may contain the composite solid electrolyte of the disclosed embodiments, a solid electrolyte other than the composite solid electrolyte of the disclosed embodiments, an electroconductive material, a binder, etc.

As the anode active material, a conventionally-known material can be used. As the anode active material, examples include, but are not limited to, a lithium metal (Li), a lithium alloy, carbon, Si, a Si alloy and Li₄Ti₅O₁₂ (LTO).

As the lithium alloy, examples include, but are not limited to, LiSn, LiSi, LiAl, LiGe, LiSb, LiP and LiIn.

As the Si alloy, examples include, but are not limited to, an alloy with a metal such as Li, and an alloy with at least one metal selected from the group consisting of Sn, Ge and Al.

By assembling the all-solid-state battery and initially charging the battery, the Si is reacted with a metal such as Li to form an amorphous alloy. An alloyed part of the Si is kept amorphized even after metal ions such as lithium ions are released by discharging the battery. In the disclosed embodiments, therefore, the anode layer comprising Si include such an embodiment that the Si is formed into amorphous alloy.

The form of the anode active material is not particularly limited. For example, it may be a particulate form or a thin film form.

When the anode active material is in a particulate form, the average particle diameter (D₅₀) of the anode active material particles may be 1 nm or more and 100 μm or less, or it may be 10 nm or more and 30 μm or less, for example.

The optional components contained in the anode layer, that is, the composite solid electrolyte of the disclosed embodiments, the solid electrolyte other than the composite solid electrolyte of the disclosed embodiments, the electroconductive material and the binder, will not be described here since they are the same as those contained in the cathode layer.

The method for forming the anode layer is not particularly limited. As the method, examples include, but are not limited to, pressure-forming a powdered anode mix that contains the anode active material and, as needed, other components.

As the anode current collector, a conventionally-known metal that is usable as a current collector in all-solid-state batteries, can be used. As the metal, examples include, but are not limited to, a metal material containing one or more elements selected from the group consisting of Cu, Ni, Al, V, Au, Pt, Mg, Fe, Ti, Co, Cr, Zn, Ge and In.

The form of the anode current collector is not particularly limited. As the form, examples include, but are not limited to, various kinds of forms such as a foil form and a mesh form.

The form of the whole anode is not particularly limited. It may be a sheet form. In this case, the thickness of the whole anode is not particularly limited. It can be determined depending on desired performance.

As needed, the all-solid-state battery comprises an outer casing for housing the cathode, the anode and the solid electrolyte layer.

The form of the outer casing is not particularly limited. As the form, examples include, but are not limited to, a laminate form.

The material for the outer casing is not particularly limited, as long as it is a material that is stable in electrolytes. As the material, examples include, but are not limited to, resins such as polypropylene, polyethylene and acrylic resin.

As the all-solid-state battery, examples include, but are not limited to, a lithium ion battery, a sodium battery, a magnesium battery and a calcium battery. The all-solid-state battery may be a lithium ion battery.

As the form of the all-solid-state battery, examples include, but are not limited to, a coin form, a laminate form, a cylindrical form and a square form.

The method for producing the all-solid-state battery of the disclosed embodiments, is not particularly limited and may be a conventionally-known method.

For example, the solid electrolyte layer is formed by pressure-forming the powdered composite solid electrolyte material containing the composite solid electrolyte. Next, the cathode layer is obtained by pressure-forming the powdered cathode mix on one surface of the solid electrolyte layer. Then, the anode layer is obtained by pressure-forming the powdered anode mix on the other surface of the solid electrolyte layer. Then, a cathode layer-solid electrolyte layer-anode layer assembly thus obtained, can be used as the all-solid-state battery.

In this case, the press pressure applied for pressure-forming the powdered composite solid electrolyte material, the powdered cathode mix and the powdered anode mix, is generally about 1 MPa or more and about 600 MPa or less.

The pressure applying method is not particularly limited. As the method, examples include, but are not limited to, applying pressure by use of a plate press machine, a roll press machine, etc.

As the method for producing the all-solid-state battery, the powdered cathode mix, the powdered composite solid electrolyte material and the powdered anode mix may be deposited and integrally formed at a time.

The production of the all-solid-state battery may be carried out in the state that moisture is removed from the system as much as possible. For example, it is thought to be effective to depressurize the inside of the system in the production steps and to replace the inside of the system by a substantially moisture-free gas (such as inert gas) in the production steps.

### EXAMPLES

### Example 1

### [Production of Composite Solid Electrolyte]

The following experiments and operations were carried out inside a glove box in which the atmosphere was controlled with Ar gas having a dew point of −70° C. or less.

As the first sulfide-based solid electrolyte particles, Li₆PS₅Cl crystal particles were prepared.

For the first sulfide-based solid electrolyte particles, the average particle diameter (D50) was 0.5 μm; the Young's modulus was 80 GPa; the aspect ratio was 2; the long axis length was 1 μm; and the lithium ion conductivity was 1 mS/cm.

As the second sulfide-based solid electrolyte particles, LiI—LiBr—Li₃PS₄ glass ceramic particles were prepared.

For the second sulfide-based solid electrolyte particles, the average particle diameter (D50) was 3 μm; the Young's modulus was 15 GPa; the aspect ratio was 1; the long axis length was 3 μm; and the lithium ion conductivity was 3.2 mS/cm.

The first sulfide-based solid electrolyte particles and the second sulfide-based solid electrolyte particles were put in a mortar and mixed at a mixing ratio (mass %) of 0.5:99.5, thereby obtaining a composite solid electrolyte.

### Example 2

The composite solid electrolyte of Example 2 was produced in the same manner as Example 1, except that the first sulfide-based solid electrolyte particles and the second sulfide-based solid electrolyte particles were put in a mortar and mixed at a mixing ratio (mass %) of 1:99.

### Example 3

The composite solid electrolyte of Example 3 was produced in the same manner as Example 1, except that the first sulfide-based solid electrolyte particles and the second sulfide-based solid electrolyte particles were put in a mortar and mixed at a mixing ratio (mass %) of 5:95.

### Example 4

The composite solid electrolyte of Example 4 was produced in the same manner as Example 1, except that the first sulfide-based solid electrolyte particles and the second sulfide-based solid electrolyte particles were put in a mortar and mixed at a mixing ratio (mass %) of 10:90.

### Example 5

The composite solid electrolyte of Example 5 was produced in the same manner as Example 1, except that the first sulfide-based solid electrolyte particles and the second sulfide-based solid electrolyte particles were put in a mortar and mixed at a mixing ratio (mass %) of 15:85.

### Example 6

The composite solid electrolyte of Example 6 was produced in the same manner as Example 1, except that the first sulfide-based solid electrolyte particles and the second sulfide-based solid electrolyte particles were put in a mortar and mixed at a mixing ratio (mass %) of 20:80.

### Comparative Example 1

The composite solid electrolyte of Comparative Example 1 was produced in the same manner as Example 1, except that the first sulfide-based solid electrolyte particles and the second sulfide-based solid electrolyte particles were put in a mortar and mixed at a mixing ratio (mass %) of 0:100, that is, the first sulfide-based solid electrolyte particles were not used, and only the second sulfide-based solid electrolyte particles were used.

### [Production of Solid Electrolyte Layers]

The solid electrolyte layer of Example 1 was produced as follows, by use of the composite solid electrolyte of Example 1.

First, the composite solid electrolyte, heptane (as a solvent) and PVdF (as a binder) were put in a polypropylene (PP) container. They were mixed by an ultrasonic homogenizer to obtain a slurry. The binder put in the PP container accounted for 2 mass % of the total mass of the composite solid electrolyte.

The thus-obtained slurry was applied on an aluminum foil by use of a doctor blade.

The applied slurry was dried at 100° C. for one hour. The dried slurry was pressed at a pressure of 6 ton/cm² (≈588 MPa), thereby obtaining the solid electrolyte layer of Example 1.

The solid electrolyte layers of Examples 2 to 6 and Comparative Example 1 were produced in the same manner as Example 1, by use of the composite solid electrolytes of Examples 2 to 6 and Comparative Example 1, respectively.

### [Measurement of the Li Ion Conductivities of the Solid Electrolyte Layers]

Then, the Li ion conductivities (mS/cm) of the solid electrolyte layers of Examples 1 to 6 and Comparative Example 1 were measured by the AC impedance measurement method. The results are shown in Table 1.

### [Peel Strength Test on the Solid Electrolyte Layers]

The peel strengths (kN/m) of the solid electrolyte layers of Examples 1 to 6 and Comparative Example 1 were measured by use of surface and interfacial cutting analysis system SAICAS (trademark) as a surface-interface physical properties analyzer. The results are shown in Table 1.

TABLE 1

| | Content rate (mass %) of | Li ion | Peel strength |
|---|---|---|---|
| | the first sulfide-based | conductivity | (kN/m) |
| | solid electrolyte particles | (mS/cm) of the | of the solid |
| | in the composite solid | solid electrolyte | electrolyte |
| | electrolyte | layer | layer |
| Comparative | 0 | 1.5 | 0.2 |
| Example 1 | | | |
| Example 1 | 0.5 | 1.4 | 0.4 |
| Example 2 | 1 | 1.3 | 0.6 |
| Example 3 | 5 | 1.2 | 0.7 |
| Example 4 | 10 | 0.9 | 0.3 |
| Example 5 | 15 | 0.9 | 0.3 |
| Example 6 | 20 | 0.8 | 0.3 |

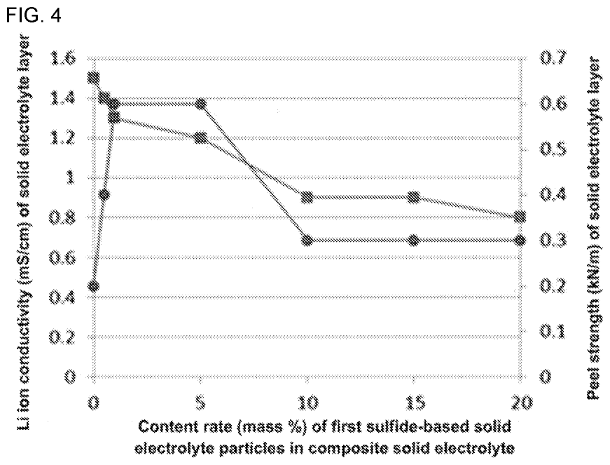

FIG. 4 is a graph showing a relation between the content rate of the first sulfide-based solid electrolyte particles in the composite solid electrolyte, the Li ion conductivity of the solid electrolyte layer, and the peel strength of the solid electrolyte layer.

The peel strengths of the solid electrolyte layers of Examples 1 to 6 are from 0.3 kN/m to 0.7 kN/m. The peel strength of the solid electrolyte layer of Comparative Example 1 is 0.2 kN/m. Accordingly, the peel strengths of the solid electrolyte layers of Examples 1 to 6 are better than the solid electrolyte layer of Comparative Example 1.

The Li ion conductivities of the solid electrolyte layers of Examples 1 to 6 are from 0.8 mS/cm to 1.4 mS/cm. The Li ion conductivity of the solid electrolyte layer of Comparative Example 1 is 1.5 mS/cm. Accordingly, it was found that while the Li ion conductivities of the solid electrolyte layers of Examples 1 to 6 are lower than the solid electrolyte layer of Comparative Example 1, the solid electrolyte layers of Examples 1 to 6 obtained desired Li ion conductivities.

Accordingly, it was proved that when the content rate of the first sulfide-based solid electrolyte particles in the composite solid electrolyte is from 0.5 mass % to 20 mass %, the solid electrolyte layer strikes a balance between Li ion conductivity and peel strength.

From the results of Examples 2 and 3, it was proved that when the content rate of the first sulfide-based solid electrolyte particles in the composite solid electrolyte is from 1 mass % to 5 mass %, the solid electrolyte layer strikes a good balance between Li ion conductivity and peel strength.

From the results of Examples 4 to 6, it was found that when the content rate of the first sulfide-based solid electrolyte particles in the composite solid electrolyte is 10 mass % or more, the peel strength of the solid electrolyte layer decreases. It is presumed that this is because, since the first sulfide-based solid electrolyte particles are relatively hard, adhesion between the particles was decreased by increasing the content rate of the first sulfide-based solid electrolyte particles.

From the above results, it is presumed that since the anchor effect was obtained between the first sulfide-based solid electrolyte particles, which are relatively small and hard particles, and the second sulfide-based solid electrolyte particles, which are relatively large and soft particles, the solid electrolyte layer having desired lithium ion conductivity and increased peel strength, was obtained.

Accordingly, it is presumed that even when the composite solid electrolyte of the disclosed embodiments is used in layers other than the solid electrolyte layer (that is, in the cathode and anode layers), as with the solid electrolyte layer, the cathode and anode layers obtain desired lithium ion conductivity and increased peel strength. Also, it is presumed that by incorporating the composite solid electrolyte of the disclosed embodiments in at least one layer selected from the group consisting of the cathode layer, the anode layer and the solid electrolyte layer, the durability of an all-solid-state battery is increased while the all-solid-state battery obtains desired output characteristics.

### REFERENCE SIGNS LIST

11. Solid electrolyte layer
12. Cathode layer
13. Anode layer
14. Cathode current collector
15. Anode current collector
16. Cathode
17. Anode
20. Composite solid electrolyte
21. First sulfide-based solid electrolyte particles
22. Second sulfide-based solid electrolyte particles
100. All-solid-state battery

1. An all-solid-state battery comprising a cathode comprising a cathode layer, an anode comprising an anode layer, and a solid electrolyte layer disposed between the cathode layer and the anode layer,
wherein the all-solid-state battery comprises a composite solid electrolyte containing first sulfide-based solid electrolyte particles and second sulfide-based solid electrolyte particles having a smaller Young's modulus than the first sulfide-based solid electrolyte particles;
wherein an average particle diameter of the first sulfide-based solid electrolyte particles is smaller than the second sulfide-based solid electrolyte particles; and
wherein the composite solid electrolyte is contained in at least one layer selected from the group consisting of the cathode layer, the anode layer and the solid electrolyte layer.

2. The all-solid-state battery according to claim 1, wherein the first sulfide-based solid electrolyte particles contained in the composite solid electrolyte account for 0.5 mass % to 15 mass % of the total mass of the composite solid electrolyte.

3. The all-solid-state battery according to claim 1, wherein the first sulfide-based solid electrolyte particles contained in the composite solid electrolyte account for 1 mass % to 5 mass % of the total mass of the composite solid electrolyte.

4. The all-solid-state battery according to claim 1, wherein a Young's modulus of the first sulfide-based solid electrolyte particles is from 30 GPa to 150 GPa, and the Young's modulus of the second sulfide-based solid electrolyte particles is from 15 GPa to 25 GPa.

5. The all-solid-state battery according to claim 1, wherein a length of a long axis of the first sulfide-based solid electrolyte particles is from 0.3 μm to 1 μm, and a length of a long axis of the second sulfide-based solid electrolyte particles is from 2 μm to 3 μm.

6. The all-solid-state battery according to claim 1, wherein an aspect ratio of the first sulfide-based solid electrolyte particles is from 1.5 to 5.0, and an aspect ratio of the second sulfide-based solid electrolyte particles is from 1.0 to 1.2.

7. The all-solid-state battery according to claim 1, wherein the first sulfide-based solid electrolyte particles are disposed in an outer peripheral region of the second sulfide-based solid electrolyte particles.

8. A composite solid electrolyte for all-solid-state batteries each comprising a cathode comprising a cathode layer, an anode comprising an anode layer, and a solid electrolyte layer disposed between the cathode layer and the anode layer,
wherein the composite solid electrolyte comprises first sulfide-based solid electrolyte particles and second sulfide-based solid electrolyte particles having a smaller Young's modulus than the first sulfide-based solid electrolyte particles, and
wherein an average particle diameter of the first sulfide-based solid electrolyte particles is smaller than the second sulfide-based solid electrolyte particles.
